(19) United States
(12) Patent Application Publication
(10) Pub. No.: US 2014/0054170 A1
(43) Pub. Date: Feb. 27, 2014

(54) BIOSENSOR DEVICE

(71) Applicants: Norihito Tsukahara, Kyoto (JP); Keiko Ikuta, Osaka (JP); Akio Oki, Kyoto (JP)

(72) Inventors: Norihito Tsukahara, Kyoto (JP); Keiko Ikuta, Osaka (JP); Akio Oki, Kyoto (JP)

(21) Appl. No.: 14/113,697

(22) PCT Filed: Feb. 17, 2012
(86) PCT No.: PCT/JP2012/001065

§ 371 Date: Oct. 24, 2013

(30) Foreign Application Priority Data
Apr. 28, 2011 (JP) 2011-101383

(51) Int. Cl. G01N 27/327

(52) U.S. Cl. CPC G01N 27/327
USPC 204/403.01

(57) ABSTRACT

A biosensor device which is possible to be downsized and potable, is free of the problem of solution outflow, and enables detection accurately and stably is realized. A biosensor device (30) having an artificial lipid membrane is provided with an artificial lipid membrane (1) having first and second membrane surfaces (1a, 1b) which are located opposite each other, a first chamber (11a) for encapsulating a first electrolyte solution (2a) in contact with the first membrane surface (1a) of the artificial lipid membrane, a second chamber (11b) for encapsulating a second electrolyte solution (2b) in contact with the second membrane surface (1b) of the artificial lipid membrane, first electrodes (3a, 3a′) for contacting the first electrolyte solution (2a) in the first chamber (11a), and second electrodes (3b, 3b′) for contacting the second electrolyte solution (2b) in the second chamber (11b), wherein the second chamber (11b) has gas permeability at its wall portion (10) for encapsulating the second electrolyte solution (2b) in at least a wall thickness direction.

### TECHNICAL FIELD

The present invention relates to a biosensor device, and more particularly to a biosensor device having an artificial lipid membrane.

### BACKGROUND ART

A biosensor which utilizes an excellent molecular recognition function of a receptor and incorporates the receptor into an artificial lipid membrane is known (See, for example, Patent Literatures 1 and 2).

A conventional biosensor is, as illustrated in FIG. 12(a), schematically configured as a biosensor system 350 wherein a sensor chip 300 is immersed in a sample solution 302 and a membrane potential of an artificial lipid membrane 301 formed on the sensor chip 300 is measured. More particularly, in the sensor chip 300 as illustrated in FIG. 12(b), a sheet 310 having a plurality of wells 308 is provided on a substrate 311, each of these wells 308 is filled with a standard solution 313, and the artificial lipid membrane 301 is formed on the standard solution 313. As a receptor, for example, a membrane protein 312 is incorporated into the artificial lipid membrane 301. An electrode 314 is formed on a bottom surface of the well 308 so as to contact the standard solution 313, and a lead 306 is connected to the electrode 314 from a rear surface side of the substrate 311. Then, as illustrated in FIG. 12(a), a test tank 303 is filled with the sample solution 302 as a detected solution, and the sensor chip 300 as described above is immersed in this sample solution 302 together with a reference electrode 304. By using a potentiometer 307 connected to the lead 306 (coated with an insulator) of the sensor chip 300 and the reference electrode 304, a potential difference between the electrode 314 and the reference electrode 304 is measured as the membrane potential of the artificial lipid membrane 301 between the sample solution 302 and the standard solution 313. With the use of the biosensor system 350 to examine changes in the membrane potential of the artificial lipid membrane 301 due to the contact with the sample solution 302, it is possible to detect a substance (molecules) contained in the sample solution 302 and measure an amount thereof.

### CITATION LIST

### Patent Literature

Patent Literature 1: JP 2005-37207 A

Patent Literature 2: JP 4-215052 A

### SUMMARY OF INVENTION

### Technical Problem

As mentioned above with reference to FIG. 12(a), since the conventional biosensor system is configured so that the test tank 303 is filled with the sample solution 302 and the sensor chip 300 and the reference electrode 304 are immersed therein, the system has to be in the form of a relatively large apparatus and it is difficult to make it downsized and portable. Further, in such a configuration, a distance between the sensor chip 300 and the reference electrode 304 provided in the test tank 303 becomes relatively large, installation positions of the sensor chip 300 and the reference electrode 304 are easily variable, a liquid level of the sample solution 302 within the test tank 303 is easily changed (for example, easily decreased by solvent evaporation etc.), and the like. Accordingly, it is not possible to measure the membrane potential accurately and stably and is not sufficient to detect changes in the membrane potential which is generally a fairly small-scale order. Moreover, every time the changes in the membrane potential are detected, it is necessary to fill the test tank 303 with the sample solution 302. Consequently, the apparatus relating to the biosensor can be provided only in the form of a system in which the sensor chip 300 is used together with the test tank 303, the reference electrode 304, and the like and cannot be provided in the form of a system where each component is integrally assembled in advance. Additionally, in order to have the above-described configuration, it is necessary to open an upper surface of the test tank 303. Thus, when the test tank 303 is vibrated or tilted, there is a problem in that the sample solution 302 can flow out from the test tank 303.

The present invention is provided in order to solve problems of the conventional biosensor system, and an object thereof is to realize a biosensor system which is possible to be downsized and potable, is free of the problem of solution outflow, and enables detection accurately and stably.

### Solution to Problem

According to the present invention, there is provided a biosensor device having an artificial lipid membrane, comprising:

an artificial lipid membrane having first and second membrane surfaces which are located opposite each other;

a first chamber for encapsulating a first electrolyte solution in contact with the first membrane surface of the artificial lipid membrane;

a second chamber for encapsulating a second electrolyte solution in contact with the second membrane surface of the artificial lipid membrane;

a first electrode for contacting the first electrolyte solution in the first chamber; and

a second electrode for contacting the second electrolyte solution in the second chamber, wherein

the second chamber has gas permeability at is wall portion for encapsulating the second electrolyte solution in at least a wall thickness direction.

Using the above-described biosensor device of the present invention, a substance to be detected can be supplied into the second electrolyte solution through the wall portion of the second chamber having gas permeability. Therefore, both the first electrolyte solution and the second electrolyte solution can be previously encapsulated in the device (more specifically, in the first chamber and the second chamber, respectively). The apparatus configuration of the present invention is fundamentally different from the configuration of the conventional biosensor system where the test tank is filled with the sample solution and the sensor chip and the reference electrode are immersed therein. According to the present invention, an apparatus relating to the biosensor can be realized in the form of the device and such a biosensor device can be miniaturized and is portable. Moreover, according to the biosensor device of the present invention, both the first electrode and the second electrode are fixedly provided in the device and can be disposed in the vicinity of the artificial lipid membrane, and both the first electrolyte solution and the second electrolyte solution are previously encapsulated in the device and can prevent the solution volumes from changing. Consequently, the membrane potential of the artificial lipid membrane can be measured accurately and stably. Further, according to the biosensor device of the present invention, since both the first electrolyte solution and the second electrolyte solution are previously encapsulated in the device, there is no problem of solution outflow.

In the biosensor device of the present invention, respective outer dimensions of the first chamber, the second chamber, and the artificial lipid membrane in a direction perpendicular to a membrane thickness direction of the artificial lipid membrane may be different or the same. It should be noted that in the present invention, regarding respective members of the first chamber, the second chamber, and the artificial lipid membrane, the outer dimensions thereof in the direction perpendicular to the membrane thickness direction of the artificial lipid membrane mean projection dimensions of the respective members when viewed from the membrane thickness direction of the artificial lipid member, and representatively understood as areas of projection domains of the respective members.

In one aspect of the biosensor device of the present invention, the outer dimension of the first chamber is smaller than the outer dimension of the second chamber in the direction perpendicular to the membrane thickness direction of the artificial lipid membrane. More specifically, the area of the projection domain of the first chamber is smaller than the area of the projection domain of the second chamber, and more preferably, the projection domain of the first chamber is included in the projection domain of the second chamber.

According to the above aspect of the present invention, in a manufacturing process of the biosensor device, a condition of the first electrolyte solution supplied in the first chamber (a supply state of the first electrolyte solution) can be easily observed through the second chamber.

In another aspect of the biosensor device of the present invention, the outer dimension of the first chamber is (substantially) the same as the outer dimension of the second chamber in the direction perpendicular to the membrane thickness direction of the artificial lipid membrane. More specifically, the area of the projection domain of the first chamber is substantially the same as the area of the projection domain of the second chamber, and more preferably, the projection domain of the first chamber and the projection domain of the second chamber substantially correspond to each other in their contours.

According to the above aspect of the present invention, pressures can be balanced between the first chamber and the second chamber, and thus the artificial lipid membrane can be retained more stably.

In still another aspect of the biosensor device of the present invention, the outer dimension of the first chamber is larger than the outer dimension of the second chamber in the direction perpendicular to the membrane thickness direction of the artificial lipid membrane. More specifically, the area of the projection domain of the first chamber is larger than the area of the projection domain of the second chamber, and preferably, the projection domain of the second chamber is included in the projection domain of the first chamber.

According to the above aspect of the present invention, when ions contained in the second electrolyte solution move to the first electrolyte solution via the artificial lipid membrane, a rapid variation on concentration of ions contained in the first electrolyte solution can be suppressed. As a result, if the second electrolyte solution has a sufficient amount of ions, the ions stably move from the second electrolyte solution to the first electrolyte solution. Thus, current detection characteristics can be improved.

In a preferable aspect of the biosensor device of the present invention, the outer dimension of the artificial lipid membrane is smaller than the outer dimension of the second chamber in the direction perpendicular to the membrane thickness direction of the artificial lipid membrane. More specifically, the area of the projection domain of the artificial lipid membrane is smaller than the area of the projection domain of the second chamber, and more preferably, the projection domain of the artificial lipid membrane is included in the projection domain of the second chamber.

According to the above aspect of the present invention, in the manufacturing process of the biosensor device, a condition of the artificial lipid membrane (supply state of a lipid solution) can be easily observed through the second chamber.

In the preferable aspect of the biosensor device of the present invention, the biosensor device further comprises a retaining member for retaining an end portion of the artificial lipid membrane between the first chamber and the second chamber, and at least a surface of the retaining member has water repellency.

According to the above aspect of the present invention, the artificial lipid membrane can be retained more stably by using the retaining member in which at least the surface is water repellent.

In the above aspect of the present invention, it is more preferable that the retaining member has at least one through-hole, and the through-hole is filled with an adhesive. Therefore, while the retaining member in which at least the surface is water repellent is used, the retaining member can be sufficiently adhered to members for defining the first chamber and the second chamber (more specifically, members for providing wall portions which respectively encapsulates the first electrolyte solution and the second electrolyte solution).

### Advantageous Effects of Invention

According to the present invention, since the biosensor device having the artificial lipid membrane is configured by appropriately incorporating the first electrolyte solution, the second electrolyte solution, the first electrode, and the second electrode, there can be provided the biosensor device which is possible to be downsized and potable, is free of the problem of solution outflow, and enables detection accurately and stably.

### BRIEF DESCRIPTION OF DRAWINGS

FIG. 1 is a schematic cross-sectional view showing a biosensor device in one embodiment of the present invention.

FIG. 2 is a partly enlarged schematic cross-sectional view of a second electrode and a periphery thereof of the biosensor device in the embodiment in FIG. 1.

FIGS. 3(a) and (b) are schematic cross-sectional views showing a manufacturing process of the biosensor device in the embodiment in FIG. 1.

FIG. 4 is a schematic cross-sectional view showing a biosensor device in another embodiment of the present invention.

FIG. 5 is a schematic cross-sectional view showing a biosensor device in still another embodiment of the present invention.

FIG. 6 is a schematic cross-sectional view showing a biosensor device in yet another embodiment of the present invention.

FIG. 7(a) is a partly enlarged schematic cross sectional view of a water repellent retaining member (water repellent substrate) and substrates thereabove and therebelow of the biosensor device in the embodiment in FIG. 6; and FIG. 7(b) is a top view of the water repellent retaining member (an adhesive not shown) as viewed on a plane A-A′ in FIG. 7(a).

FIGS. 8(a) and (b) are drawings corresponding to the top view of the water repellent retaining member (the adhesive not shown) in FIG. 7(b), and showing variations of the water repellent retaining member.

FIG. 9 is a schematic cross-sectional view showing a laminated body of substrates (and thermosetting adhesive sheets) in the manufacturing process of the biosensor device of an example of the present invention.

FIG. 10 is a drawing showing steps of supplying solutions to the laminated body of the substrates (and the thermosetting adhesive sheets) in the manufacturing process of the biosensor device of the example of the present invention; FIG. 10(a) shows a step of supplying a first electrolyte solution; FIG. 10(b) shows a step of supplying a lipid solution; FIG. 10(c) shows a step of supplying a second electrolyte solution; and FIG. 10(d) shows a completed biosensor device.

FIG. 11(a) shows a current response waveform of the biosensor device of the example of the present invention; and FIG. 11(b) shows a current response waveform of a device of a comparative example.

FIGS. 12(a) and (b) are drawings showing a conventional biosensor system; FIG. 12(a) shows a schematic perspective view of the biosensor system as a whole; and

FIG. 12(b) shows an enlarged schematic cross-sectional view of a sensor chip.

### DESCRIPTION OF EMBODIMENTS

Various embodiments of the present invention will be described below by referring to the drawings.

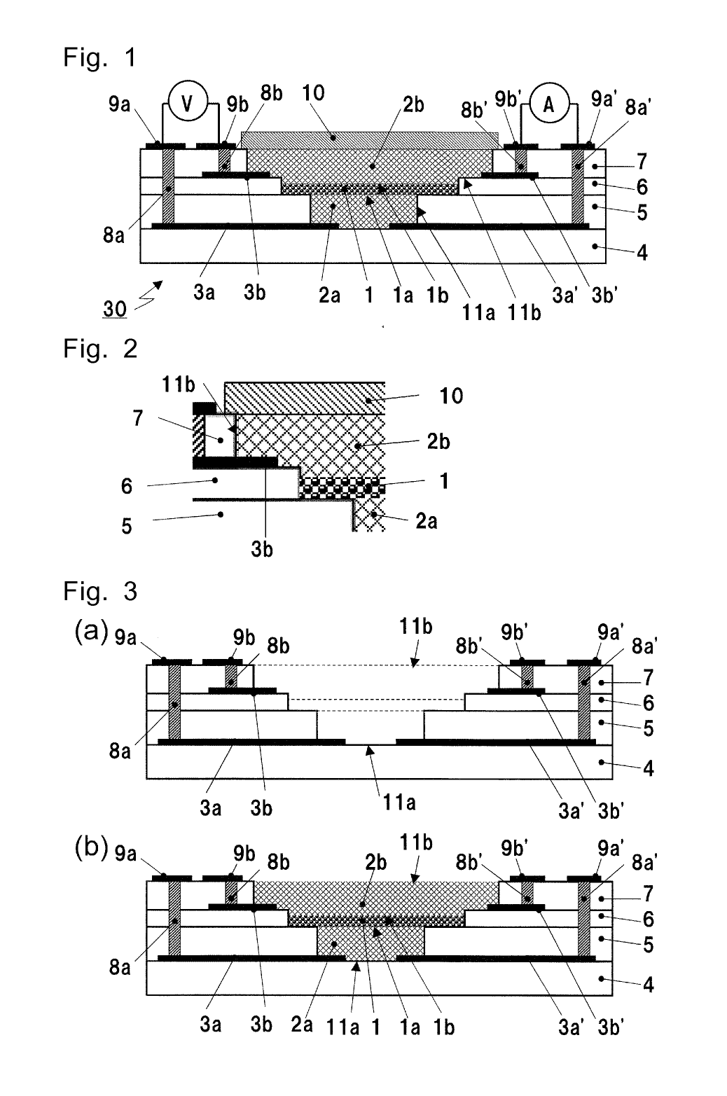

As illustrated in FIG. 1, a biosensor device in one embodiment of the present invention is configured by including: an artificial lipid membrane 1 having a first membrane surface la and a second membrane surface lb which are located opposite each other; a first chamber 11a for encapsulating a first electrolyte solution 2a in contact with the first membrane surface 1a of the artificial lipid membrane 1; a second chamber 11b for encapsulating a second electrolyte solution 2b in contact with the second membrane surface 1b of the artificial lipid membrane 1; first electrodes 3a and 3a′ contacting the first electrolyte solution 2a in the first chamber 11a; and second electrodes 3b and 3b′ contacting the second electrolyte solution 2b in the second chamber 11b.

The artificial lipid membrane 1 can be formed using a lipid solution obtained by dispersing or dissolving a lipid in a solvent.

Any of appropriate lipids may be used for the lipid. In particular, complex lipids including phosphoric acid and/or sugar in molecules, and more specifically, phospholipids, glycolipids, lipoproteins, sulfolipids, or the like are preferable. Phospholipids are the most preferable. Examples of the phospholipids include glycerophospholipids (e.g., phosphatidylcholine (lecithin), phosphatidylethanolamine, phosphatidylserine, diphytanoyl phosphatidylcholine, and dipalmitoyl phosphatidylcholine) and sphingophospholipids (e.g., sphingomyelin). Further, the lipid may be any of simple lipids (e.g., glycerol monooleate) or derived lipids. The lipid may be any of naturally-derived lipids, for example, asolectin (soybean phospholipid) or synthetic lipids. Since the synthetic lipids are easily obtained with highly purity and chemical stability, the synthetic lipids are more preferable. A fatty acid portion of the lipid is preferably saturated fatty acid or unsaturated fatty acid having a carbon number of 10 to 20. Such lipids may be used singly or in combination of two or more thereof.

The solvent can be appropriately selected in accordance with the lipid. Generally, an organic solvent, preferably a saturated hydrocarbon, is used. Examples of the solvent include decane, hexadecane, hexane, chloroform, and the like. Such solvents may be used singly or in combination of two or more thereof.

A concentration of the lipid to the solvent is preferably 1 to 50 mg and more preferably 4 to 40 mg of the lipid with respect to 1 mL of the solvent.

The artificial lipid membrane 1 is preferably a lipid bimolecular membrane. The thickness of the artificial lipid membrane 1 can be, for example, about 2 to 10 nm. In accordance with a substance to be detected, a receptor (not shown), such as a membrane protein or an ion channel, can be incorporated into the artificial lipid membrane 1.

The first electrolyte solution 2a and the second electrolyte solution 2b may be the same electrolyte solution or different electrolyte solutions. The electrolyte solutions may be a solution in which an ionic material is dissolved in a polar solvent, and can be selected appropriately in accordance with the composition of the artificial lipid membrane 1.

As the ionic material, for example, sodium chloride (NaCl), potassium chloride (KCl), calcium chloride (CaCl₂), magnesium chloride (MgCl₂), sodium dihydrogenphosphate (NaH₂PO₄), sodium hydrogenphosphate (Na₂HPO₄), and the like can be used singly or in combination of two or more thereof.

As the polar solvent, for example, water, glycerin, sugar, sugar alcohol, ethanol, isopropyl alcohol, ethylene glycol, sorbitol, xylitol, dipropylene glycol, butylene glycol, polyethylene glycol, polyoxyethylene methyl glucoside, maltitol, mannitol, glucose, and the like can be used singly or in combination of two or more thereof.

The first electrolyte solution 2a and the second electrolyte solution 2b preferably have osmotic pressures within the range of 280 to 330 mOsm/kg-H₂O, but limited thereto. Alternatively, for the first electrolyte solution 2a and the second electrolyte solution 2b, it is preferable to use a general solution used in an electrophysiological experiment. Further, it is also preferable that viscosities of the first electrolyte solution 2a and the second electrolyte solution 2b are adjusted by adding organic compounds or high molecules (polymers).

The first electrolyte solution 2 and the second electrolyte solution 3 may be different or the same in any one or more of the concentrations, the viscosities, and the osmotic pressures.

The first chamber 11a and the second chamber 11b can have any appropriate structures as far as the first electrolyte solution 2a and the second electrolyte solution 2b are respectively encapsulated in the interior thereof, liquid-tightly (except for portions where the first electrolyte solution 2a and the second electrolyte solution 2b contact the first membrane surface 1a and the second membrane surface 1b of the artificial lipid membrane 1)

In the illustrated embodiment, substrates 5, 6, and 7 each provided with a hole (or well) are laminated on a substrate 4, and the artificial lipid membrane 1 is formed by contacting (retained by) an upper surface of the substrate 5 and a lower inner wall surface of the substrate 6. In such an embodiment, the first chamber 11a is a region defined (or surrounded) by an upper surface of the substrate 4 and an inner wall surface of the substrate 5, and the second chamber 11b is a region defined by an upper inner wall surface of the substrate 6, an inner wall surface of the substrate 7, and a lower surface of a lid 10. In other words, the substrates 4 and 5 are members for defining the first chamber 11a. The substrates 6 and 7, and the lid 10 are members for defining the second chamber 11b. The substrates 5 and 6 are also retaining members for retaining an end portion(s) of the artificial lipid membrane 1.

The lid 10, which is one of the members for defining the second chamber 11b, is understood as a wall portion for encapsulating the second electrolyte solution 2b in the second chamber 11b. In the present embodiment, this lid 10 has gas permeability in at least a wall thickness direction (i.e., between the second electrolyte solution 2b and an exterior of the lid 10). The lid 10 is formed of a material having liquid-tightness (a liquid, more particularly, the second electrolyte solution does not permeate) and having gas permeability in at least the wall thickness direction and generally in all directions (a gas, for example, odor molecules of a substance to be detected permeates). For example, as the lid 10, it is possible to use one composed of a material such as polydimethylsiloxane (PDMS), silicone resin, Teflon (registered trademark), polyolefin, polyethylene, or the like.

On the other hand, the substrates 4, 5, 6, and 7 can be composed of any appropriate material having liquid tightness. For example, the substrates 4, 5, 6, and 7 are composed of an organic material such as polyethylene terephthalate (PET), polyethylene naphthalate (PEN), polyphenylene sulfide (PPS), acrylonitrile-butadiene-styrene copolymer (ABS resin), acrylic resin (e.g., polymethyl methacrylate (PMMA)), cyclic polyolefin, or polycarbonate. However, the material is not limited to these and the substrates 4, 5, 6, and 7 may be composed of an inorganic material, such as glass, silicon, aluminum oxide, silicon oxide, or silicon nitride. These substrates 4, 5, 6, and 7 may be adhered by an adhesive layer (e.g., a thermosetting film, not shown) therebetween.

Heights of the substrates 5, 6, and 7 and shapes and sizes (viewed from the membrane thickness direction) of the holes formed thereon may be appropriately determined in accordance with dimensions and locations of the first chamber 11a and the second chamber 11b as desired.

In the illustrated embodiment, in a direction perpendicular to the membrane thickness direction of the artificial lipid membrane 1, an outer dimension of the first chamber 11a (a hole area of the substrate 5) is set smaller than an outer dimension of the second chamber 11b (a hole area of the substrate 7). More specifically, the hole area of the substrate 5 is set smaller than an hole area of the substrate 6, and the hole area of the substrate 6 is set smaller than the hole area of the substrate 7. Moreover, when viewed from the membrane thickness direction of the artificial lipid membrane 1, a projection domain of the hole of the substrate 5 is included in a projection domain of the hole of the substrate 6, and a projection domain of the hole of the substrate 6 is included in a projection domain of the hole of the substrate 7. Therefore, in a manufacturing process of the biosensor device, a condition of the first electrolyte solution 2a supplied in the first chamber 11a (supply state of the first electrolyte solution 2a) and further a condition of the artificial lipid membrane 1 (supply state of the lipid solution) can be easily observed through the second chamber 11b.

In order to measure a membrane potential of the artificial lipid membrane 1, a first electrode and a second electrode are disposed in the device so as to (at least partially) contact the first electrolyte solution 2a and the second electrolyte solution 2b, respectively. More specifically, the first electrode is disposed in contact with the first electrolyte solution 2a in the first chamber 11a. For example, as illustrated, the two first electrodes 3a and 3a′ can be formed separately from each other on the upper surface of the substrate 4. The second electrode is disposed in contact with the second electrolyte solution 2b in the second chamber 11b. For example, as illustrated, the two second electrodes 3b and 3b′ can be formed separately from each other on the upper surface of the substrate 6. In this way, as illustrated in FIG. 2 which enlarges the second electrode 3b and a periphery thereof, the second electrodes 3b and 3b′ can be disposed in a vicinity of the artificial lipid membrane 1.

Terminals 9a, 9a′, 9b, and 9b′ are formed on the upper surface of the substrate 7, and can be electrically connected to the first electrodes 3a, 3a′ and the second electrodes 3b, 3b′ through interlayer connection vias 8a, 8a′, 8b, and 8b′, respectively. The terminals 9a and 9b are connection terminals to a power source (abstractly shown in a symbol “V” in the drawing) and the terminals 9a′ and 9b′ are connection terminals to an ammeter (abstractly shown in a symbol “A” in the drawing).

The biosensor device 30 of the present embodiment can be manufactured, for example, as follows.

First, the substrates 4, 5, 6, and 7 are prepared. The holes are formed on the substrates 5, 6, and 7. The shape of each of the holes is not particularly limited and may be, for example, circular, elliptical, rectangular, polygonal, or the like, and may be the same (similar) or different each other. In the present embodiment, sizes of these holes (for example, in case of circular holes, they are represented by diameters of the holes) are selected in such a manner that the sizes thereof for the substrates 5, 6, and 7 increase in this order. The first electrodes 3a and 3a′ are formed on the upper surface of the substrate 4, and the second electrodes 3b and 3b′ are formed on the upper surface of the substrate 6.

Via holes for the interlayer connection vias 8a, 8a′, 8b, and 8b′ are formed in the substrates 5, 6, and 7. Then, these via holes are filled with a conductive paste including conductive filler, for example, metal filler such as Ag or Cu, so that the interlayer connection vias 8a, 8a′, 8b, and 8b′are formed. Alternatively, the interlayer connection vias 8a, 8a′, 8b, and 8b′ may be formed by plate processing with Au, Cu, and Ag, or the like on the inner wall surfaces of the via holes. Thereafter, the terminals 9a, 9a′, 9b, and 9b′ are formed on the interlayer connection vias 8a, 8a′, 8b, and 8b′ (on the upper surface of the substrate 7). It should be noted that timings for forming the interlayer connection vias and the terminals are not particularly limited and may be formed in a later step.

The substrates 4, 5, 6, and 7 obtained in this way are aligned, laminated, and adhered to each other. For example, by laminating these substrates with the thermosetting film (not shown) therebetween and by thermally treating (e.g., thermocompression) thus obtained laminated body, the substrates can be adhered with the thermosetting film hardened therebetween. Moreover, for example, when these substrates are formed of the organic material(s) (an organic film(s)), by laminating these substrates and thermally treating thus obtained laminated body, the substrates can be thermally fused and adhered each other.

Accordingly, as illustrated in FIG. 3(a), the substrates 4, 5, 6, and 7 are laminated and adhered, thereby forming a stepped space therein. A lower portion, a center portion, and an upper portion of this space (indicated separately by dotted lines in the drawing) correspond to the first chamber 11a, the artificial lipid membrane 1, and the second chamber 11b.

Next, the first electrolyte solution 2a, the lipid solution, and the second electrolyte solution 2b are sequentially supplied in this stepped space. It is preferable that the first electrolyte solution 2a, the lipid solution, and the second electrolyte solution 2b are supplied quantitatively in accordance with volumes to be occupied by the first chamber 11a, the artificial lipid membrane 1, and the second chamber 11b. The quantitative supply of the first electrolyte solution 2a, the lipid solution, and the second electrolyte solution 2b can be carried out, for example, by an ink-jet manner, a dispense manner, a transfer manner, and the like.

As illustrated in FIG. 3(b), the lipid solution supplied as described above forms the artificial lipid membrane 1 between the first electrolyte solution 2a and the second electrolyte solution 2b, wherein the first membrane surface 1a contacts the first electrolyte solution 2a and the second membrane surface lb contacts the second electrolyte solution 2b. The artificial lipid membrane 1 contacts an inner wall surface of the stepped space and can be retained on this inner wall surface by a surface tension or the like of the artificial lipid membrane 1. In the present embodiment, the artificial lipid membrane 1 is formed so as to contact the upper surface of the substrate 5 and the lower inner wall surface of the substrate 6, and therefore the artificial lipid membrane 1 can be retained stably.

Thereafter, the lid 10 is placed so as to cover the second electrolyte solution 2b, and a peripheral portion of the lid 10 is adhered to an upper surface of the substrate 7. The adhesion is carried out at ordinary temperature by, for example, expressing self-adhering ability of the lid 10 or using an ordinary temperature hardening-type adhesive.

As described above, the biosensor device 30 of the present embodiment shown in FIG. 1 can be manufactured.

The biosensor device 30 of the present embodiment can be used as follows.

First, in absence of a substance to be detected, a voltage is applied to the electrodes 3a and 3b through the terminals 9a and 9b connected to the power source, and therefore the voltage is applied between the first membrane surface 1a and the second membrane surface 1b of the artificial lipid membrane 1. In this state, a current flowing in the membrane thickness direction of the artificial lipid membrane 1 is measured as a current flowing between the electrodes 3a′ and 3b′ by the ammeter connected to the terminals 9a′ and 9b′. If the artificial lipid membrane 1 is appropriately formed so as to separate the first electrolyte solution 2a and the second electrolyte solution 2b from each other, the artificial lipid membrane 1 generally exhibits insulation property in absence of the substance to be detected, so that the current does not flow substantially.

Next, a predetermined amount of the substance to be detected is dissolved or dispersed in the second electrolyte solution 2b, and the current flowing in the membrane thickness direction of the artificial lipid membrane 1 is measured in the same manner as described above. At this time, the substance to be detected may be supplied in the second electrolyte solution through the gas-permeable lid 10, or the biosensor device 30 may be manufactured using the second electrolyte solution in which the substance to be detected is previously dispersed or dissolved. In presence of the substance to be detected, the substance to be detected affects the receptor incorporated into the artificial lipid membrane 1, and thus the current flows according to the amount of the substance to be detected. Consequently, a plurality of current measurement values are collected by varying the amount of substance to be detected which is dissolved or dispersed in the second electrolyte solution 2b, and thereby the calibrated data can be obtained.

Using the biosensor device 30 for which the calibrated data is previously obtained as described above, a sample gas is supplied in the second electrolyte solution 2b through the gas-permeable lid 10. Then, a current flowing in the membrane thickness direction of the artificial lipid membrane 1 is measured in the same way as described above. From the measured current value, existence of the substance to be detected in the sample gas and, if the substance to be detected exists, the amount thereof can be examined. The biosensor device 30 may be used in a disposable manner or may be recycled by replacing the second electrolyte solution 2b with a new electrolyte solution.

According to the present embodiment, unlike the conventional biosensor system, it is not necessary to fill the test tank with the sample solution and immerse the sensor chip and the reference electrode therein. Accordingly, all of the first electrolyte solution, the second electrolyte solution, the first electrodes, and the second electrodes can be previously incorporated into the device, and the biosensor device 30 suitable for downsizing and portability is realized. In the biosensor device 30, in addition to the first electrodes 3a and 3a′, the second electrodes 3b and 3b′ are also disposed in the vicinity of the artificial lipid membrane 1, and respective solution volumes of the first electrolyte solution 2a and the second electrolyte solution 2b can be strictly controlled based on volume designs of the first chamber 11a and the second chamber 11b. Therefore, the membrane potential of the artificial lipid membrane 1 can be measured accurately and stably. Furthermore, according to the biosensor device 30, since both the first electrolyte solution and the second electrolyte solution are previously encapsulated in the device, there is no problem of solution outflow.

It should be noted that in the present embodiment, the first electrodes 3a and 3a′ and the second electrodes 3b and 3b′ are provided in the biosensor device 30, that the voltage is applied between the first membrane surface la and the second membrane surface 1b of the artificial lipid membrane 1 using the first electrode 3a and the second electrode 3b, and that the current flowing in the membrane thickness direction of the artificial lipid membrane 1 is measured using the first electrode 3a′ and the second electrode 3b′. This configuration is particularly preferable when a minute ion current is measured with high precision. However, the present invention is not limited to this. As far as the membrane potential of the artificial lipid membrane 1 can be measured, the number of the first electrode and the second electrode may be one for each of the first electrolyte solution and the second electrolyte solution, and any one of the current and the voltage may be measured.

The biosensor device of one embodiment of the present invention has been described hereinbefore. However, this can be modified in various ways and biosensor devices in other various embodiments can be also provided. The biosensor devices in other embodiments will be described below with an emphasis on modifications. Unless otherwise noted, descriptions similar to the above embodiment are applied to the other embodiments.

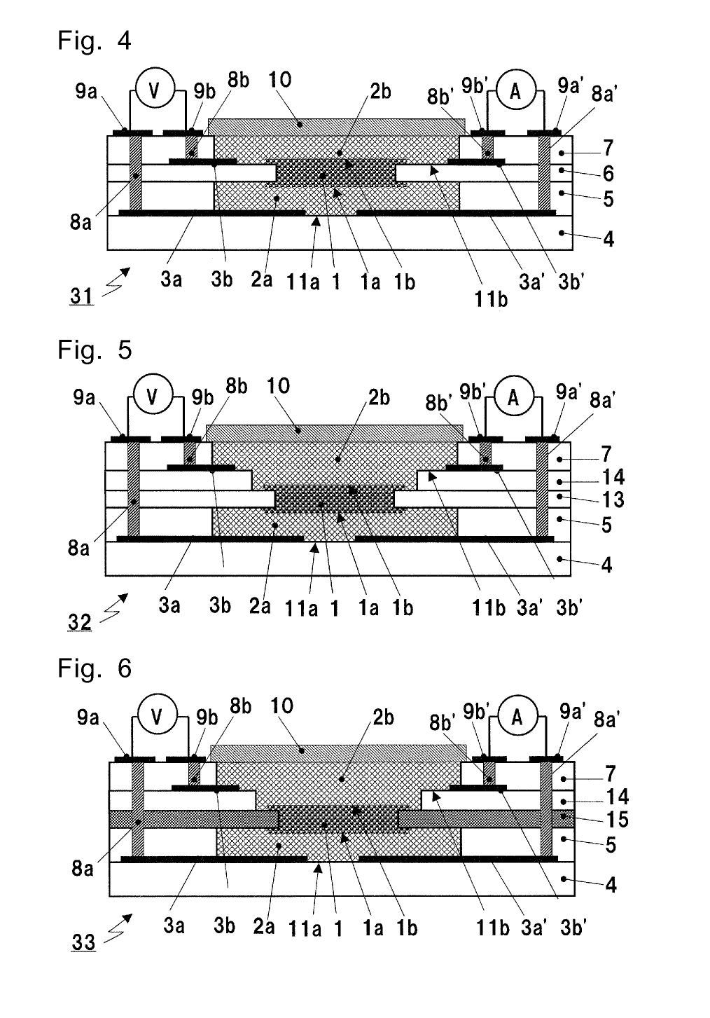

As illustrated in FIG. 4 as another embodiment of the present invention, in a biosensor device 31, in a direction perpendicular to a membrane thickness direction of an artificial lipid membrane 1, an outer dimension of the artificial lipid membrane 1 (which may be considered to be substantially the same as the hole area of the substrate 6) is set smaller than an outer dimension of a first chamber 11a (the hole area of the substrate 5) and an outer dimension of a second chamber 11b (the hole area of the substrate 7). More specifically, the hole area of the substrate 6 is set smaller than the hole area of the substrate 5 and is set smaller than the hole area of the substrate 7. Further, when viewed from the membrane thickness direction of the artificial lipid membrane 1, a projection domain of the hole of the substrate 6 is included in a projection domain of the hole of the substrate 5 and is also included in a projection domain of the hole of the substrate 7. In this way, in a manufacturing process of the biosensor device, a condition of the artificial lipid membrane 1 (supply state of a lipid solution) can be easily observed through the second chamber 11b.

Further, in the biosensor device 31 shown in FIG. 4, in the direction perpendicular to the membrane thickness direction of the artificial lipid membrane 1, the outer dimension of the first chamber 11a (the hole area of the substrate 5) is substantially the same as the outer dimension of the second chamber (the hole area of the substrate 7). Further, when viewed from the membrane thickness direction of the artificial lipid membrane 1, the projection domain of the hole of the substrate 5 and the projection domain of the hole of the substrate 7 correspond to each other in their contours. In this way, pressures can be balanced between the first chamber 11a and the second chamber 11b, and thus the artificial lipid membrane 1 can be retained more stably.

As illustrated in FIG. 5 as still another embodiment of the present invention, in a biosensor device 32, separate substrates 13 and 14 are used in place of the substrate 6 in the biosensor device 31 shown in FIG. 4. The substrate 13 is a retaining member for retaining an end portion(s) of an artificial lipid membrane 1 between a first chamber 11a and a second chamber 11b. The substrate 14 is a member for defining the second chamber 11b. Second electrodes 3b and 3b′ are formed on an upper surface of the substrate 14. More specifically, a hole area of the substrate 13 is set smaller than a hole area of the substrate 14. With this structure, it is assured that the artificial lipid membrane 1 does not contact the second electrodes 3b and 3b′. It should be noted that the substrates 13 and 14 may be formed of the same material as the substrate 6.

As illustrated in FIG. 6 as still another embodiment of the present invention, in a biosensor device 33, a substrate 15 at least surface of which is water repellent (also simply referred to as “water repellent substrate” in the present specification) may be used in place of the substrate 13 in the biosensor device 32 shown in FIG. 5. The water repellent substrate 15 is a retaining member for retaining an end portion(s) of an artificial lipid membrane 1 between a first chamber 11a and a second chamber 11b. In this way, the water repellent substrate 15 can stably retain the artificial lipid membrane 1. Regarding the water repellency, it is preferable that a contact angle to water is, for example, 60° or more (less than 180°), and typically 70° to 120°. At least the surface of the water repellent substrate (water repellent retaining member) can be formed of a material such as fluorocarbon resin, polytetrafluoroethylene (PTFE), Teflon (registered trademark) or the like.

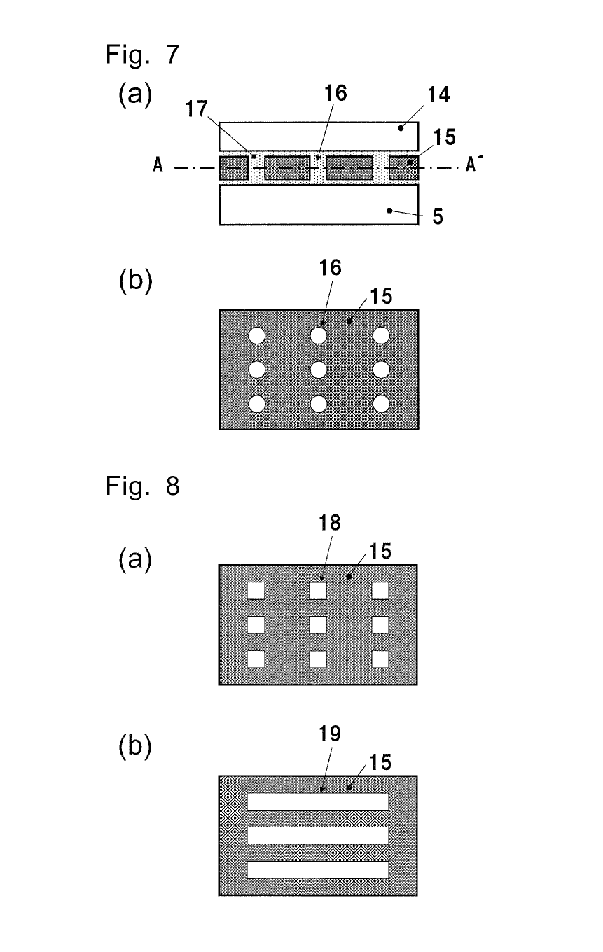

When the water repellent substrate 15 is used as the retaining member of the artificial lipid membrane 1, adherence of the water repellent substrate 15 to other substrates (the substrates 5 and 14 in the embodiment shown in FIG. 6) can be difficult by simply applying an adhesive onto its adherend surface. Accordingly, as illustrated in FIG. 7(a), it is preferable that one or more, preferably a plurality of, through-holes 16 are provided on the water repellent substrate 15, and the through-holes 16 are filled with an adhesive 17. According to such configuration, the water repellent substrate 15 can be sufficiently adhered to the substrate 5 defining the first chamber 11a and to the substrate 14 defining the second chamber 11b with the adhesive 17 filled into the through-holes 16.

The shape of the through-holes 16 (viewed form a membrane thickness direction) formed on the water repellent substrate 15 is not particularly limited. In addition to the through-holes 16 which have a circular shape in FIG. 7(b), the through-holes may be, for example, square through-holes 18 shown in FIG. 8(a) or rectangular (or slotted) through-holes 19 shown in FIG. 8(b). The through-holes can have any other shape. When there are a plurality of through-holes, through-holes having two or more different shapes may be mixed. When there are a plurality of through-holes, positions of the through-holes are not particularly limited. However, it is preferable that the through-holes are disposed evenly on the adherend surface.

### EXAMPLES

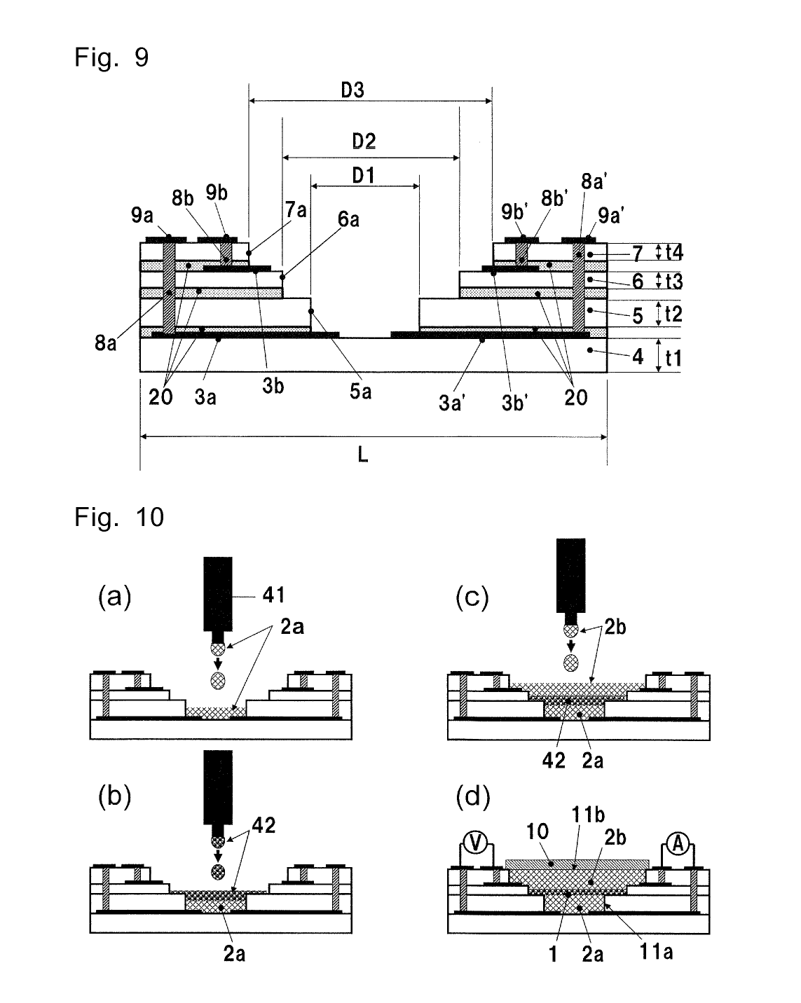

In this example, the biosensor device 30 in the above-described embodiment referring to FIGS. 1 through 3 was manufactured. The present example is described below referring to FIGS. 9 and 10. Unless otherwise noted, descriptions similar to the aforementioned embodiment referring to FIGS. 1 through 3 are applied to the present example.

First, substrates 4, 5, 6, and 7 were prepared. A sheet formed of polyethylene terephthalate (PET) was used for each of the substrates 4, 5, 6, and 7, where a thickness t1 of the substrate 4 was 100 μm, a thickness t2 of the substrate 5 was 100 μm, a thickness t3 of the substrate 6 was 20 μm, a thickness t4 of the substrate 7 was 20 μm (see FIG. 9 to be described below). Circular holes 5a, 6a, and 7a were respectively formed on these substrates 5, 6, and 7, where a diameter D1 of the hole 5a was 200 μm, a diameter D2 of the hole 6a was 400 μm, a diameter D3 of the hole 7a was 500 μm. These holes were formed by using a punching machine.

Then, the electrodes 3a and 3a′ were formed on the upper surface of the substrate 4, and the electrodes 3b and 3b′ were formed on the upper surface of the substrate 6. The electrodes 3a, 3a′, 3b, and 3b′ were formed according to the following procedure. First, a pattern made of Cu with a thickness of 12 μm was formed on each the substrate 4 and the substrate 6 as electrode bases. Next, an outer peripheral surface of this pattern was plated with Ag. Finally, the outer peripheral surface plated with Ag was further coated with AgCl using a sodium hypochlorite aqueous solution (5% by weight).

Via holes with a diameter of 150 μm for the interlayer connection vias 8a, 8a′, 8b, and 8b′ were formed on the substrates 5, 6, and 7 by using the punching machine. Then, these via holes were filled with a conductive paste including a Cu powder coated with Ag as metal filler, and thereby the interlayer connection vias 8a, 8a′, 8b, and 8b′were formed. The terminals 9a, 9a′, 9b, and 9b′ were formed of Cu on these interlayer connection vias 8a, 8a′, 8b, and 8b′.

Thus obtained substrates 4, 5, 6, and 7 were aligned, laminated and adhered to each other according to the following procedure. Three thermosetting adhesive sheets 20 with a thickness of 20 μm each were used for adhering of the substrates 4, 5, 6, and 7 (see FIG. 9). On these thermosetting adhesive sheets 20, through-holes were formed at positions corresponding to the respective holes of the substrates 5, 6, and 7 and the via holes for the interlayer connection vias 8a, 8a′, 8b, and 8b′ beforehand. As illustrated in FIG. 9, the substrates 4, 5, 6, and 7 and the three thermosetting adhesive sheets 20 were laminated in such a manner that each of the thermosetting adhesive sheets 20 was interposed in between the substrates 4, 5, 6, and 7, and aligned with the respective holes and the via holes. By thermally compressing (heating and pressurizing) the laminated body thus obtained at 150° C., the substrates 4, 5, 6, and 7 were adhered to each other. The outer size L of the laminated body adhered in this way (and therefor the biosensor device eventually obtained) was 30 mm.

Next, as illustrated in FIG. 10(a), 3.7 nL of the first electrolyte solution 2a was supplied into the laminated body obtained as described above using an ink-jet apparatus 41 capable of supplying droplets quantitatively. The supply amount of the first electrolyte solution 2a corresponded to the volume to be occupied by a first chamber 11a. A mixture of 100 mmol/L of potassium chloride (KCl) aqueous solution and glycerin with a volume ratio of 50%:50% was used for the first electrolyte solution 2a.

Then, as illustrated in FIG. 10(b), 2.5 nL of a lipid solution 42 was supplied onto the above-supplied first electrolyte solution 2a using similarly the ink-jet apparatus 41. The supply amount of the lipid solution 42 corresponded to the volume to be occupied by the artificial lipid membrane 1. A solution obtained by dissolving 10 mg of a phospholipid (lecithin) in 1 mL of decane was used for the lipid solution 42.

Further, as illustrated in FIG. 10(c), 8.0 nL of the second electrolyte solution 2b was supplied onto the above-supplied lipid solution 42 using similarly the ink-jet apparatus 41. The supply amount of the second electrolyte solution 2b corresponded to the volume to be occupied by the second chamber 11b. Similarly to the first electrolyte solution 2a, a mixture of 100 mmol/L of potassium chloride (KCl) aqueous solution and glycerin with a volume ratio of 50%:50% was used for the second electrolyte solution 2b.

Thereafter, as illustrated in FIG. 10(d), the lid 10 was placed so as to cover the second electrolyte solution 2b and a peripheral portion of the lid 10 was adhered to the substrate 7 with a self-adhering ability. A sheet formed of polydimethylsiloxane (PDMS) with a thickness of 100 μm was used for the lid 10.

Accordingly, the biosensor device of the present example was completed. The artificial lipid membrane 1 can be naturally formed of the lipid solution 42 between the first electrolyte solution 2a and the second electrolyte solution 2b without requiring an additional step.

A function evaluation of the completed biosensor device was carried out as follows.

As illustrated in FIG. 10(d), a pulse voltage of 20 mV (a pulse width of 10 microseconds) was applied to the artificial lipid membrane through the terminals connected to a power source (abstractly shown in a symbol “V” in the drawing). In this state, a current response flowing in the membrane thickness direction of the artificial lipid membrane 1 was measured by an ammeter (abstractly shown in a symbol “A” in the drawing) connected to the terminals. A patch clamp amplifier (manufactured by HEKA, model number EPC-10) was used for the power source and the ammeter, and the current measured was recorded over time.

On the other hand, as a comparative example, a device of the comparative example was manufactured in a manner similar to the present example except that a lipid solution 42 was not supplied (accordingly, an entire space within the device was equally filled with a first electrolyte solution and a second electrolyte solution which are the same). A function evaluation of this device was carried out in the same way as described above.

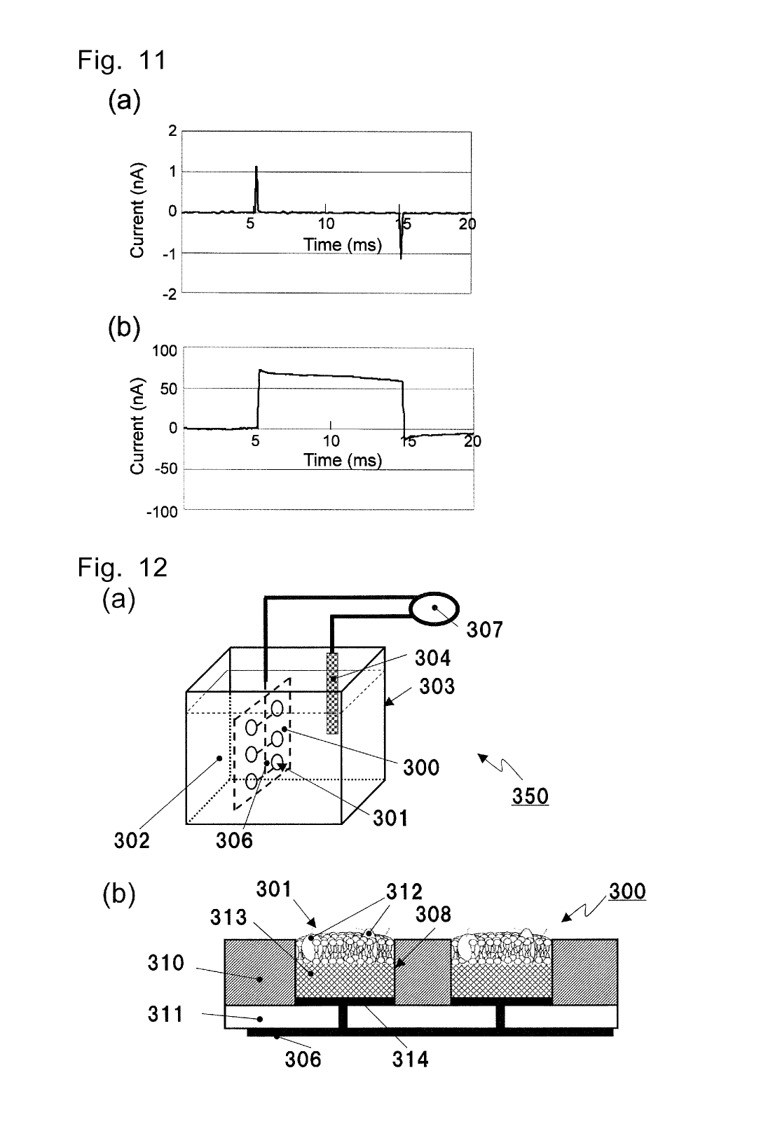

FIG. 11(a) shows a current response waveform of the biosensor device of the present example, and FIG. 11(b) shows a current response waveform of the device of the comparative example. Referring to FIG. 11(b), in the device of the comparative example, a waveform indicating that the current always flowed was observed during application of a pulse voltage. It is understood that this is because the artificial lipid membrane does not exist in the device of the comparative example. In contrast, referring to FIG. 11(a), a current response waveform indicating insulation was observed in the biosensor device of the present example. This shows that, in the biosensor device of the present example, the insulating artificial lipid membrane 1 is appropriately formed so as to separate the first electrolyte solution 2a and the second electrolyte solution 2b from each other.

Therefore, it becomes possible in the biosensor device of the present example to detect the substance to be detected by incorporating a receptor into the artificial lipid membrane depending on a target substance to be detected.

### INDUSTRIAL APPLICABILITY

The biosensor device of the present invention is widely applicable to the fields of environment, food, housing, automobile, security, etc. such as a biomolecular analyzing apparatus, an air pollutant analyzing apparatus and so on. Further, the biosensor device of the present invention is widely applicable to the fields of medicine, healthcare, etc. such as a lifestyle related disease diagnostic apparatus, a urine diagnostic apparatus, a breath diagnostic apparatus, a stress measuring instrument, and so on.

### REFERENCE SIGNS LIST

1 Artificial lipid membrane

1a First membrane surface

1b Second membrane surface

2a First electrolyte solution

2b Second electrolyte solution

3a, 3a′ First electrode

3b, 3b′ Second electrode

4, 5, 6, 7 Substrate

5a, 6a, 7a Hole

8a, 8b, 8a′, 8b′ Interlayer connection via

9a, 9b, 9a′, 9b′ Terminal

10 Lid

11a First chamber

11b Second chamber

13, 14 Substrate

15 Water repellent substrate (water repellent retaining member)

16, 18, 19 Through-hole

17 Adhesive

30, 31, 32, 33 Biosensor device

41 Ink-jet apparatus

42 Lipid solution

300 Sensor chip

301 Artificial lipid membrane

302 Sample solution

303 Test tank

304 Reference electrode

306 Lead

307 Potentiometer

308 Well

310 Sheet

311 Substrate

312 Membrane protein

313 Standard solution

314 Electrode

350 Biosensor system

1. A biosensor device having an artificial lipid membrane, comprising:
an artificial lipid membrane having first and second membrane surfaces which are located opposite each other;
a first chamber for encapsulating a first electrolyte solution in contact with the first membrane surface of the artificial lipid membrane;
a second chamber for encapsulating a second electrolyte solution in contact with the second membrane surface of the artificial lipid membrane;
a first electrode for contacting the first electrolyte solution in the first chamber; and
a second electrode for contacting the second electrolyte solution in the second chamber, wherein the second chamber has gas permeability at its wall portion for encapsulating the second electrolyte solution in at least a wall thickness direction.

2. The biosensor device according to claim 1, wherein an outer dimension of the first chamber is smaller than an outer dimension of the second chamber in a direction perpendicular to a membrane thickness direction of the artificial lipid membrane.

3. The biosensor device according to claim 1, wherein an outer dimension of the first chamber is an identical to an outer dimension of the second chamber in a direction perpendicular to a membrane thickness direction of the artificial lipid membrane.

4. The biosensor device according to claim 1, wherein an outer dimension of the first chamber is larger than an outer dimension of the second chamber in a direction perpendicular to a membrane thickness direction of the artificial lipid membrane.

5. The biosensor device according to claim 1, wherein an outer dimension of the artificial lipid membrane is smaller than an outer dimension of the second chamber in a direction perpendicular to a membrane thickness direction of the artificial lipid membrane.

6. The biosensor device according to claim 1, further comprising a retaining member for retaining an end portion of the artificial lipid membrane between the first chamber and the second chamber, wherein at least a surface of the retaining member has water repellency.

7. The biosensor device according to claim 6, wherein the retaining member has at least one through-hole and the through-hole is filled with an adhesive.
